(19) United States
(12) Patent Application Publication
(10) Pub. No.: US 2026/0110649 A1
(43) Pub. Date: Apr. 23, 2026

(54) X-RAY FLUORESCENCE SPECTROMETER

(71) Applicant: RIGAKU CORPORATION, Akishima-shi, TOKYO (JP)

(72) Inventors: Shinya HARA, Takatsuki-shi, OSAKA (JP); Yasujiro YAMADA, Takatsuki-shi, OSAKA (JP); Natsumi OKAZAKI, Takatsuki-shi, OSAKA (JP)

(73) Assignee: RIGAKU CORPORATION, Akishima-shi, TOKYO (JP)

(21) Appl. No.: 19/158,145

(22) PCT Filed: Feb. 15, 2024
(86) PCT No.: PCT/JP2024/005270

§ 371 Date: Aug. 20, 2025

(30) Foreign Application Priority Data
Feb. 24, 2023 (JP) 2023-027359

(51) Int. Cl. G01N 23/223; G01N 23/2209

(52) U.S. Cl. CPC G01N 23/223; G01N 23/2209; G01N 2223/076; G01N 2223/3037

(57) ABSTRACT

In an X-ray fluorescence spectrometer of the present invention, a quantification unit causes a displaying unit to display, as a quantitative-value theoretical standard deviation regarding an analytical component, a difference between a first quantitative value of the analytical component based on measured intensities regarding respective components and a second quantitative value of the analytical component obtained by causing, in calibration curve equations for the respective components, the measured intensities regarding the respective components to fluctuate in a direction in which change in the content of the analytical component increases.

### CROSS REFERENCE TO THE RELATED APPLICATION

This application is based on and claims Convention priority to Japanese patent application No. 2023-027359, filed Feb. 24, 2023, the entire disclosure of which is herein incorporated by reference as a part of this application.

### BACKGROUND OF THE INVENTION

### Field of the Invention

The present invention relates to an X-ray fluorescence spectrometer that irradiates a sample with primary X-rays and that obtains, on the basis of measured intensities of fluorescent X-rays generated through the irradiation, a content of a component in the sample by a quantification unit in which a calibration curve method that involves performing absorption/excitation correction and overlap correction is employed or a fundamental parameter method that includes overlap correction is employed.

### Description of Related Art

Conventionally, X-ray fluorescence spectrometers that perform quantitative analysis are roughly classified into: X-ray fluorescence spectrometers that perform quantitative analysis based on a calibration curve method; and X-ray fluorescence spectrometers that perform quantitative analysis based on a fundamental parameter method (also written as “FP method”). In the quantitative analysis based on the calibration curve method, in order to analyze an unknown sample, a set of standard samples in which contents (also written as “concentrations”) of components are known is used to obtain a calibration curve as a correlation between the content of each of the components and the measured intensity of fluorescent X-rays (measurement line) from a measurement element corresponding to the component. The component is an element or a compound. When the component is an element, the element itself is the measurement element corresponding to the component, and meanwhile, when the component is a compound, an element representing the compound is the measurement element corresponding to the component (see, for example, Patent Document 1 (paragraph [0002])).

In the quantitative analysis based on the calibration curve method, absorption/excitation correction (also written as “matrix correction”) related to absorption/excitation due to a coexisting element and overlap correction related to overlapping of an interfering line are sometimes performed in addition to background correction related to a background (see, for example, Patent Document 1 (paragraph [0003]) for absorption/excitation correction).

Meanwhile, in the quantitative analysis based on the FP method, a theoretical intensity of fluorescent X-rays generated from each of components in a sample is calculated on the basis of respective assumed contents of the components, and the respective assumed contents of the components are corrected and calculated through successive approximation such that the theoretical intensity matches a post-conversion measured intensity obtained by converting a measured intensity measured by a detection unit into a theoretical intensity scale. Consequently, a content of the component in the sample is calculated. Here, in order to analyze an unknown sample, a set of standard samples in which contents of components are known is used to obtain an instrument sensitivity curve as a correlation between a measured intensity and a theoretical intensity calculated on the basis of the known contents (see, for example, Patent Document 2 (paragraph [0003] and FIG. 4) and Patent Document 1 (paragraph [0009])).

In the quantitative analysis based on the FP method, in principle, absorption/excitation correction is performed on all the components, and as necessary, overlap correction is also performed for some of the components in an instrument sensitivity curve expressed with, for example, the following equation (a) (see, for example, Patent Document 2 (paragraphs [0069] to [0074]) for absorption/excitation correction).

$${I}_{T i} = {aI}_{i}^{3} + {bI}_{i}^{2} + {cI}_{i} + d + {\sum }_{j} {bo}^{ij} {I}_{j} \qquad ( a )$$

I_{T}: theoretical intensity
I: measured intensity
a, b, c, d: instrument sensitivity constants
i: analytical component
j: overlap correction component
b_{O}^{ij}: overlap correction coefficient of component j with respect to component i

In the quantitative analysis based on the calibration curve method, at the time of creating a calibration curve, it is required to, as a criterion for determining whether or not to perform correction, calculate and display a standard deviation of a quantitative value that is obtained from the calibration curve and that is a content of an analytical component. In addition, after the analysis, it is required to, as a reliability of such a quantitative value, calculate and display a standard deviation of the quantitative value.

In the quantitative analysis based on the FP method as well, it is required to, as a criterion for determining whether or not to perform overlap correction, calculate and display a standard deviation of a quantitative value that is obtained through the FP method including the overlap correction, and, after the analysis, it is required to, as a reliability of such a quantitative value, calculate and display a standard deviation of the quantitative value.

In this manner, calculation of a standard deviation in such quantitative analysis that involves performing absorption/excitation correction and overlap correction should be performed in consideration of the fact that an error in analysis of a correction component influences an error in analysis of an analytical component, i.e., in consideration of error propagation to the analytical component due to the correction component. However, there is no method for calculating a quantitative-value theoretical standard deviation (a theoretical standard deviation of a quantitative value), with influence of a correction component being reflected. Thus, to date, analysis is actually performed iteratively on the same sample, and a standard deviation is calculated on the basis of a plurality of obtained quantitative values.

Conventional technologies related to analysis precision as a reliability of a quantitative value include an X-ray fluorescence spectrometer described in, for example, Patent Document 3. In the X-ray fluorescence spectrometer, a measurement time taken to obtain a specified analysis precision is calculated and displayed. However, in this calculation as well, influence of a correction component is not reflected.

### RELATED DOCUMENT

### Patent Document

[Patent Document 1] JP Laid-open Patent Publication No. 2021-51053
[Patent Document 2] WO2018/168939
[Patent Document 3] JP Laid-open Patent Publication No. 2000-65765

### SUMMARY OF THE INVENTION

To date, in quantitative analysis that involves performing absorption/excitation correction and overlap correction, analysis has to be actually performed iteratively on the same sample in order to obtain a standard deviation of a quantitative value with influence of a correction component being reflected, and the iterative analysis takes time. In addition, in the calibration curve method, there is no index for determining whether or not to perform correction at the time of creating a calibration curve before actual analysis, and, in the FP method, there is no index for determining whether or not to perform overlap correction before actual analysis.

The present invention has been made in view of the above conventional problem, and an object of the present invention is to provide an X-ray fluorescence spectrometer that obtains a content of a component in a sample by a quantification unit in which a calibration curve method that involves performing absorption/excitation correction and overlap correction is employed or a fundamental parameter method that includes overlap correction is employed, the spectrometer enabling a quantitative-value theoretical standard deviation to be obtained and displayed within an allowable time without actually performing analysis iteratively, with influence of a correction component being appropriately reflected.

To achieve the object, a first configuration of the present invention is, firstly, an X-ray fluorescence spectrometer including a quantification unit in which a calibration curve method that involves performing absorption/excitation correction and overlap correction is employed, the X-ray fluorescence spectrometer being configured to irradiate a sample with primary X-rays and obtain a content of a component in the sample by the quantification unit on the basis of measured intensities of fluorescent X-rays generated through the irradiation. In addition, the quantification unit obtains, on the basis of measured intensities regarding an analytical component and a correction component, a content of the analytical component from calibration curve equations for the analytical component and the correction component, the content being regarded as a first quantitative value.

Furthermore, the quantification unit causes, in the calibration curve equation for the analytical component, the measured intensity regarding the analytical component to fluctuate by a predetermined amount in a direction in which the content of the analytical component increases or decreases and causes, in the calibration curve equation for the correction component, the measured intensity regarding the correction component to fluctuate by a predetermined amount in a same direction as the direction in which the measured intensity regarding the analytical component has been caused to fluctuate.

Moreover, the quantification unit obtains, on the basis of the measured intensities regarding the analytical component and the correction component and post-fluctuation measured intensities regarding the analytical component and the correction component, a content of the analytical component from the calibration curve equations for the analytical component and the correction component, the content being regarded as a second quantitative value, and causes a displaying unit to display, as a quantitative-value theoretical standard deviation, a difference between the first quantitative value and the second quantitative value.

In the X-ray fluorescence spectrometer according to the first configuration, the quantification unit causes the displaying unit to display, as the quantitative-value theoretical standard deviation regarding the analytical component, the difference between the first quantitative value of the analytical component based on the measured intensities regarding the respective components and the second quantitative value of the analytical component obtained by causing, in the calibration curve equations for the respective components, the measured intensities regarding the respective components to fluctuate in the direction in which change in the content of the analytical component increases. Here, the fluctuation of the measured intensities is caused without considering, in the calibration curve equation for the correction component, change in the content of an additional correction component. Therefore, the quantitative-value theoretical standard deviation regarding the analytical component can be obtained and displayed within an allowable time without actually performing analysis iteratively, with influence of a correction component being appropriately reflected.

A second configuration of the present invention is, firstly, an X-ray fluorescence spectrometer including a quantification unit in which a fundamental parameter method that includes overlap correction is employed, the X-ray fluorescence spectrometer being configured to irradiate a sample with primary X-rays and obtain a content of a component in the sample by the quantification unit on the basis of measured intensities of fluorescent X-rays generated through the irradiation. In addition, the quantification unit obtains, on the basis of measured intensities regarding respective components, contents of the respective components from theoretical intensity equations for the respective components, the contents being regarded as first quantitative values.

Furthermore, the quantification unit increases, in each of the theoretical intensity equations for the respective components, a content of each of components other than an analytical component one by one by a predetermined amount. Then, the quantification unit causes, when a theoretical intensity regarding the analytical component increases to have a value equal to or larger than a predetermined threshold value, fluctuation so as to decrease the measured intensity regarding the component other than the analytical component by a predetermined amount. Meanwhile, the quantification unit causes, when the theoretical intensity regarding the analytical component decreases to have a value equal to or smaller than a predetermined threshold value, fluctuation so as to increase the measured intensity regarding the component other than the analytical component by the predetermined amount.

Moreover, the quantification unit obtains, on the basis of the measured intensities regarding the respective components and post-fluctuation measured intensities regarding the respective components, contents of the respective components from the theoretical intensity equations for the respective components, the contents being regarded as second quantitative values, and causes a displaying unit to display, as a quantitative-value theoretical standard deviation, a difference between the first quantitative value and the second quantitative value of each of the components.

In the X-ray fluorescence spectrometer according to the second configuration, the quantification unit causes the displaying unit to display, as the quantitative-value theoretical standard deviation, the difference between the first quantitative value based on the measured intensities regarding the respective components and the second quantitative value obtained by causing the measured intensities, which inflict significant influences on the theoretical intensities regarding the analytical components in the theoretical intensity equations for the respective components, to fluctuate in the direction in which the contents of the respective analytical components increase. Consequently, the quantitative-value theoretical standard deviation can be obtained and displayed within an allowable time without actually performing analysis iteratively, with influence of a correction component being appropriately reflected.

Any combination of at least two constructions, disclosed in the appended claims and/or the specification and/or the accompanying drawing should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of a preferred embodiment thereof, when taken in conjunction with the accompanying drawing. However, the embodiment and the drawing are given only for the purpose of illustration and explanation, and are not to be taken as limiting the scope of the present invention in any way whatsoever, which scope is to be determined by the appended claims. In the accompanying drawing, like reference numerals are used to denote like parts throughout the several views, and:

FIG. 1 is a schematic diagram showing an X-ray fluorescence spectrometer according to an embodiment of the present invention.

### DESCRIPTION OF THE EMBODIMENTS

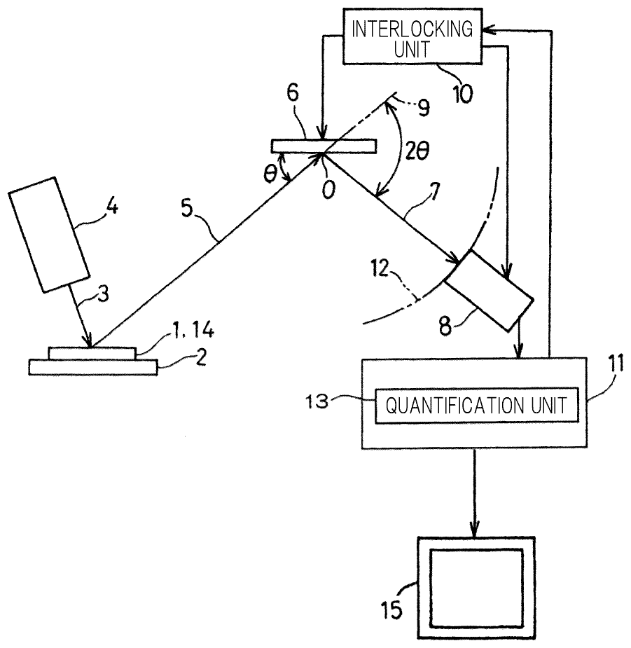

Hereinafter, an X-ray fluorescence spectrometer according to an embodiment of the present invention will be described. As shown in FIG. 1, the X-ray fluorescence spectrometer according to the present embodiment is a sequential X-ray fluorescence spectrometer that irradiates a sample 1, 14 (including both an unknown sample 1 and a standard sample 14) with primary X-rays 3 and that measures intensities of secondary X-rays 5 generated through the irradiation. The X-ray fluorescence spectrometer includes: a sample stage 2 on which the sample 1, 14 is placed; an X-ray source 4 (such as an X-ray tube) which irradiates the sample 1, 14 with the primary X-rays 3; a spectroscopic device 6 which monochromates the secondary X-rays 5 (such as fluorescent X-rays) generated from the sample 1, 14; and a detector 8 on which secondary X-rays 7 obtained through the monochromation by the spectroscopic device 6 are incident and which detects an intensity of the secondary X-rays 7. An output of the detector 8 is input through an amplifier, a pulse height analyzer, a counting unit, and the like which are not shown, to a controller 11 (such as a computer) for controlling the entire spectrometer.

The X-ray fluorescence spectrometer according to the present embodiment is a wavelength dispersive and sequential X-ray fluorescence spectrometer and includes an interlocking unit 10 (i.e., so-called goniometer) which interlocks the spectroscopic device 6 and the detector 8 so as to change the wavelengths of the secondary X-rays 7 to be incident on the detector 8. When the secondary X-rays 5 are incident on the spectroscopic device 6 at a certain incident angle θ, an extension line 9 of the secondary X-rays 5 and the secondary X-rays 7 obtained through the monochromation (diffraction) by the spectroscopic device 6 form a spectroscopic angle 2θ which is 2 times the incident angle θ. The interlocking unit 10 rotates the spectroscopic device 6 about an axis O passing through the center of a surface of the spectroscopic device 6 and perpendicular to the drawing sheet and rotates the detector 8 around the axis O along a circle 12 by an angle that is 2 times the angle of the rotation of the spectroscopic device 6 such that: the spectroscopic angle 2θ is changed so as to change the wavelengths of the secondary X-rays 7 to be obtained through the monochromation; and the secondary X-rays 7 obtained through the monochromation are incident on the detector 8. The value of the spectroscopic angle 2θ (2θ angle) is input from the interlocking unit 10 to the controller 11. In the present invention, the X-ray fluorescence spectrometer may be a wavelength dispersive and simultaneous multi-elements analysis type X-ray fluorescence spectrometer or may be an energy dispersive X-ray fluorescence spectrometer.

The X-ray fluorescence spectrometer according to the present embodiment includes a quantification unit 13 as a program installed in the controller 11 and obtains, on the basis of measured intensities of the fluorescent X-rays 5, contents of components in the sample 1, 14 by the quantification unit 13 in which a calibration curve method that involves performing absorption/excitation correction and overlap correction is employed. A quantitative-value theoretical standard deviation is obtained as follows. First, the quantification unit 13 obtains, on the basis of measured intensities Iᵢ, Iⱼ and Iₖ regarding an analytical component i and correction components j and k, a content Wᵢ of the analytical component i from calibration curve equations (e.g., the following calibration curve equations (1) to (3)) for the analytical component i and the correction components j and k in the same manner as in a conventional quantification unit. Then, this content Wᵢ of the analytical component i is regarded as a first quantitative value Qᵢ₁.

$${W}_{i} = ( {A}_{i} {I}_{i}^{3} + {B}_{i} {I}_{i}^{2} + {C}_{i} {I}_{i} + {D}_{i} ) ( 1 + {C}_{M}^{ji} {W}_{j} ) + {Co}^{ki} {W}_{k} \qquad ( 1 )$$

$${W}_{j} = ( {A}_{j} {I}_{j}^{3} + {B}_{j} {I}_{j}^{2} + {C}_{j} {I}_{j} + {D}_{j} ) ( 1 + {C}_{M}^{kj} {W}_{k} ) \qquad ( 2 )$$

$${W}_{k} = ( {A}_{k} {I}_{k}^{3} + {B}_{k} {I}_{k}^{2} + {C}_{k} {I}_{k} + {D}_{k} ) \qquad ( 3 )$$

Wᵢ: content of analytical component i
Wⱼ, Wₖ: contents of correction components j and k
Iᵢ: measured intensity regarding analytical component i
Iⱼ, Iₖ: measured intensities regarding correction components j and k
A, B, C, D: calibration curve constants
C_{M}^{ji}: absorption/excitation correction coefficient of component j with respect to component i
C_{O}^{ki}: overlap correction coefficient of component k with respect to component i

Furthermore, the quantification unit 13 causes, in the calibration curve equation (1) for the analytical component i, the measured intensity Iᵢ regarding the analytical component i to fluctuate by a predetermined amount in a direction in which the content Wᵢ of the analytical component i increases or decreases, e.g., a direction in which the content Wᵢ of the analytical component i increases, such that the measured intensity Iᵢ increases in a case where the value obtained by performing partial differentiation on the right-hand side of the calibration curve equation (1) by the measured intensity Iᵢ is a positive value.

Along with this fluctuation, the quantification unit 13 causes, in each of the calibration curve equations (2) and (3) for the correction components j and k, the corresponding one of the measured intensities Iⱼ and Iₖ regarding the correction components j and k to fluctuate by a predetermined amount in the same direction as the direction in which the measured intensity Iᵢ regarding the analytical component i has been caused to fluctuate (i.e., in this case, the direction in which the content Wᵢ of the analytical component i increases). The correction component j related to absorption or excitation is such that, in a case where the correction coefficient C_{M}^{ji} is for absorption correction, increase in the content Wⱼ of the correction component j leads to increase in the content Wᵢ of the analytical component i. Considering this, in a case where the value obtained by performing partial differentiation on the right-hand side of the calibration curve equation (2) by the measured intensity Iⱼ is a positive value, the measured intensity Iⱼ is increased by the corresponding predetermined amount. The overlap correction component is such that decrease in the content Wₖ of the correction component k leads to increase in the content Wᵢ of the analytical component i. Considering this, in a case where the value obtained by performing partial differentiation on the right-hand side of the calibration curve equation (3) by the measured intensity Iₖ is a positive value, the measured intensity Iₖ is decreased by the corresponding predetermined amount. Here, the predetermined amounts by which the fluctuation is caused are theoretical standard deviations σIᵢ, σIⱼ and σIₖ of the respective measured intensities Iᵢ, Iⱼ and Iₖ and are each obtained by using a measurement time tₘₑₐₛ, according to σI=(I/1000tₘₑₐₛ)^{1/2}.

Moreover, the quantification unit 13 obtains, on the basis of a set of, the measured intensities Iᵢ, Iⱼ and Iₖ regarding the analytical component i and the correction components j and k, and post-fluctuation measured intensities Iᵢ+σIᵢ, Iⱼ+σIⱼ and Iₖ−σIₖ regarding the analytical component i and the correction components j and k, a content Wᵢ of the analytical component i from the calibration curve equations (1) to (3) for the analytical component i and the correction components j and k. That is, Iᵢ is substituted with Iᵢ+σIᵢ, Iⱼ is substituted with Iⱼ+σIⱼ, and Iₖ is substituted with Iₖ−σIₖ, to obtain a content Wᵢ of the analytical component i. Then, with this content Wᵢ of the analytical component i being regarded as a second quantitative value Qᵢ₂, the quantification unit 13 causes a displaying unit 15 (such as a liquid crystal display) connected to the controller 11 to display, as a quantitative-value theoretical standard deviation σQᵢ, a difference |Qᵢ₂−Qᵢ₁| between the first quantitative value Qᵢ₁ and the second quantitative value Qᵢ₂.

In the X-ray fluorescence spectrometer according to the present embodiment, the quantification unit 13 causes the displaying unit 15 to display, as the quantitative-value theoretical standard deviation σQᵢ regarding the analytical component i, the difference |Qᵢ₂−Qᵢ₁| between the first quantitative value Qᵢ₁ of the analytical component i based on the measured intensities Iᵢ, Iⱼ and Iₖ regarding the respective components i, j and k and the second quantitative value Qᵢ₂ of the analytical component i based on Iᵢ+σIᵢ, Iⱼ+σIⱼ and Iₖ−σIₖ which are respectively obtained by causing, in the calibration curve equations (1) to (3) for the respective components i, j and k, the measured intensities Iᵢ, Iⱼ and Iₖ to fluctuate in the direction in which change in the content Wᵢ of the analytical component i increases. Here, the fluctuation of the measured intensities Iᵢ, Iⱼ and Iₖ is caused without considering, in the calibration curve equation (2) for the correction component j, change in the content Wₖ of an additional correction component, i.e., the correction component k. The reason why the measured intensity Iₖ is caused to fluctuate in consideration of change in the content Wₖ of the component k in the above example, is because the component k serves as an overlap correction component with respect to the analytical component i in the calibration curve equation (1) for the analytical component i, and is not because the component k serves as an additional correction component with respect to the correction component j in the calibration curve equation (2) for the correction component j. In this manner, the number of the measured intensities to be caused to fluctuate is appropriately limited, whereby the quantitative-value theoretical standard deviation regarding the analytical component i can be obtained and displayed within an allowable time without actually performing analysis iteratively, with influences of the correction components j and k being appropriately reflected.

The quantification unit 13 of the X-ray fluorescence spectrometer according to the present embodiment can also obtain contents of the components in the sample 1, 14 by employing a fundamental parameter method that includes overlap correction. In this case, a quantitative-value theoretical standard deviation is obtained as follows. First, the quantification unit 13 obtains, on the basis of a set of measured intensities Iᵢ regarding respective components i, a set of contents Wᵢ of respective components i from a set of publicly-known theoretical intensity equations for respective components i in the same manner as in a conventional quantification unit. Then, the obtained contents Wᵢ of the respective components i are regarded as first quantitative values Qᵢ₁.

Here, in the case of the fundamental parameter method, correction of all components in a sample is considered in relation to absorption/excitation. In addition, overlap correction is also considered for an instrument sensitivity curve as described in the explanations in “(Description of Related Art)”. Thus, it is necessary to: clarify each of correction components j as to whether the correction component j has absorbed or excited an analytical line (fluorescent X-rays corresponding to an analytical component i); and determine whether to increase or decrease an analytical line intensity (measured intensity Iⱼ) regarding the correction component j. Considering this necessity, an analytical line theoretical intensity I_{Tij} regarding the analytical component i is calculated with a content Wⱼ of each of the components j in the sample other than the analytical component i being changed one by one by a predetermined amount with respect to a sample composition based on the first quantitative values Qᵢ₁ of the respective components i. Then, when the analytical line theoretical intensity I_{Tij} is higher than an analytical line theoretical intensity I_{Ti0} in the sample composition based on the first quantitative values Qᵢ₁ of the respective components i, it is determined that the correction component j has excited the analytical line. Meanwhile, when the analytical line theoretical intensity I_{Tij} is lower than the analytical line theoretical intensity I_{Ti0}, it is determined that the correction component j has absorbed the analytical line.

Furthermore, in the case where the correction component j has excited the analytical line, the analytical line intensity Iⱼ regarding this correction component j is decreased by a predetermined amount. Meanwhile, in the case where the correction component j has absorbed the analytical line, the analytical line intensity Iⱼ regarding this correction component j is increased by the predetermined amount. Here, the intensities Iⱼ of the analytical lines of all the components j other than the analytical component i in the sample may be caused to fluctuate, to perform quantification calculation for obtaining a second quantitative value Qᵢ₂ described later. However, by setting a threshold value for the change amount of the analytical line intensity I_{Tij} relative to change in the content Wⱼ of each of the correction components j and performing, for a correction component j having a change amount equal to or smaller than the threshold value, quantification calculation without changing the analytical line of the correction component j, the time for calculation can be shortened.

For example, if a component i, a component j and a component k are assumed to be present in the sample, contents Wᵢ, Wⱼ and Wₖ of the respective components i, j and k are, for a composition in the sample, obtained first from measured intensities Iᵢ, Iⱼ and Iₖ by employing the fundamental parameter method. The analytical line theoretical intensity regarding the component i in this composition is defined as I_{Ti0}. Then, a theoretical intensity is calculated with the content Wⱼ of the component j being changed by a predetermined amount, and the analytical line theoretical intensity regarding the component i at this time is defined as I_{Tij}. When I_{Tij} is higher than I_{Ti0}, the component j has excited the analytical line of the component i. Then, the analytical line intensity Iⱼ regarding the correction component j is decreased by a predetermined amount. A similar processing is performed on the component k as well, to determine whether to increase or decrease the analytical line intensity Iₖ regarding the correction component k by a predetermined amount.

The above description is summarized as follows. That is, the quantification unit 13 of the X-ray fluorescence spectrometer according to the present embodiment increases, in each of the theoretical intensity equations for the respective components i, the content Wⱼ of each of the components j other than the analytical component one by one by a predetermined amount. Then, the quantification unit 13 causes, when the theoretical intensity I_{Ti} regarding the analytical component i increases to have a value equal to or larger than a predetermined threshold value as a result of the increase in the content Wⱼ, fluctuation so as to decrease the measured intensity Iⱼ regarding the component j other than the analytical component by a predetermined amount. Meanwhile, the quantification unit 13 causes, when the theoretical intensity I_{Ti} regarding the analytical component i decreases to have a value equal to or smaller than a predetermined threshold value as a result of the increase in the content Wⱼ, fluctuation so as to increase the measured intensity Iⱼ regarding the component j other than the analytical component by the predetermined amount.

Here, the predetermined amounts by which the respective measured intensities Iᵢ, Iⱼ and Iₖ are caused to fluctuate are theoretical standard deviations σIᵢ, σIⱼ and σIₖ of the respective measured intensities Iᵢ, Iⱼ and Iₖ and are each obtained by using the measurement time tₘₑₐₛ, according to σI=(I/1000tₘₑₐₛ)^{1/2}. Also, the predetermined amount by which the content Wⱼ of the component j other than the analytical component is increased is, for example, Wⱼ×0.01, the theoretical intensity I_{Ti} being equal to or larger than a predetermined threshold value means that the theoretical intensity I_{Ti} is equal to or larger than, for example, I_{Ti}×1.01, and the theoretical intensity I_{Ti} being equal to or smaller than a predetermined threshold value means that the theoretical intensity I_{Ti} is equal to or smaller than, for example, I_{Ti}×0.99.

Moreover, the quantification unit 13 obtains, on the basis of the set of, the measured intensities Iᵢ regarding the respective components I, and post-fluctuation measured intensities Iᵢ+σIᵢ or Iᵢ−σIᵢ regarding the respective components i, the set of contents Wᵢ of the respective components i from the set of theoretical intensity equations for the respective components i. Then, with the obtained contents Wᵢ of the respective components i being regarded as respective second quantitative values Qᵢ₂, the quantification unit 13 causes the displaying unit 15 to display, as a quantitative-value theoretical standard deviation σQᵢ, the difference |Qᵢ₂−Qᵢ₁| between the first quantitative value Qᵢ₁ and the second quantitative value Qᵢ₂ of each of the components i.

In a case where the quantification unit 13 employs the fundamental parameter method that includes overlap correction, the X-ray fluorescence spectrometer according to the present embodiment is as follows. That is, the quantification unit 13 causes the displaying unit 15 to display, as the quantitative-value theoretical standard deviation σQᵢ, the difference between the first quantitative value Qᵢ₁ based on the measured intensity Iᵢ regarding each of the components i and the second quantitative value Qᵢ₂ obtained by causing the measured intensities Iⱼ and Iₖ, which inflict significant influences on the theoretical intensity I_{Ti} regarding the analytical component i in the theoretical intensity equation for the component i, to fluctuate in the direction in which the content Wᵢ of the analytical component i increases. Consequently, the quantitative-value theoretical standard deviation σQᵢ can be obtained and displayed within an allowable time without actually performing analysis iteratively, with influences of the correction components j and k being appropriately reflected.

Although the present invention has been fully described in connection with the preferred embodiment thereof with reference to the accompanying drawing which is used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

1, 14 . . . sample
3 . . . primary X-rays
5 . . . fluorescent X-rays
13 . . . quantification unit
15 . . . displaying unit

What is claimed is:

1. An X-ray fluorescence spectrometer comprising a quantification unit in which a calibration curve method that involves performing absorption/excitation correction and overlap correction is employed, the X-ray fluorescence spectrometer being configured to irradiate a sample with primary X-rays and obtain a content of a component in the sample by the quantification unit on the basis of measured intensities of fluorescent X-rays generated through the irradiation, wherein
the quantification unit
obtains, on the basis of measured intensities regarding an analytical component and a correction component, a content of the analytical component from calibration curve equations for the analytical component and the correction component, the content being regarded as a first quantitative value,
causes, in the calibration curve equation for the analytical component, the measured intensity regarding the analytical component to fluctuate by a predetermined amount in a direction in which the content of the analytical component increases or decreases,
causes, in the calibration curve equation for the correction component, the measured intensity regarding the correction component to fluctuate by a predetermined amount in a same direction as the direction in which the measured intensity regarding the analytical component has been caused to fluctuate,
obtains, on the basis of the measured intensities regarding the analytical component and the correction component and post-fluctuation measured intensities regarding the analytical component and the correction component, a content of the analytical component from the calibration curve equations for the analytical component and the correction component, the content being regarded as a second quantitative value, and
causes a displaying unit to display, as a quantitative-value theoretical standard deviation, a difference between the first quantitative value and the second quantitative value.

2. An X-ray fluorescence spectrometer comprising a quantification unit in which a fundamental parameter method that includes overlap correction is employed, the X-ray fluorescence spectrometer being configured to irradiate a sample with primary X-rays and obtain a content of a component in the sample by the quantification unit on the basis of measured intensities of fluorescent X-rays generated through the irradiation, wherein
the quantification unit
obtains, on the basis of measured intensities regarding respective components, contents of the respective components from theoretical intensity equations for the respective components, the contents being regarded as first quantitative values,
increases, in each of the theoretical intensity equations for the respective components, a content of each of components other than an analytical component one by one by a predetermined amount,
causes, when a theoretical intensity regarding the analytical component increases to have a value equal to or larger than a predetermined threshold value, fluctuation so as to decrease the measured intensity regarding the component other than the analytical component by a predetermined amount,
causes, when the theoretical intensity regarding the analytical component decreases to have a value equal to or smaller than a predetermined threshold value, fluctuation so as to increase the measured intensity regarding the component other than the analytical component by the predetermined amount,
obtains, on the basis of the measured intensities regarding the respective components and post-fluctuation measured intensities regarding the respective components, contents of the respective components from the theoretical intensity equations for the respective components, the contents being regarded as second quantitative values, and
causes a displaying unit to display, as a quantitative-value theoretical standard deviation, a difference between the first quantitative value and the second quantitative value of each of the components.
